(19) United States
(12) Patent Application Publication
(10) Pub. No.: US 2012/0285418 A1
(43) Pub. Date: Nov. 15, 2012

(54) FUEL INJECTION METHOD FOR DIESEL ENGINES WITH INJECTION NOZZLES ARRANGED IN A TANGENTIAL MANNER ON THE PERIPHERY OF THE CYLINDER

(76) Inventors: Güenter Elsbett, Roth (DE); Otto Daude, Hambuhren (DE)

(21) Appl. No.: 13/510,817

(22) PCT Filed: Nov. 16, 2010
(86) PCT No.: PCT/EP2010/067580

§ 371 Date: Aug. 1, 2012

(30) Foreign Application Priority Data
Nov. 18, 2009 (DE) 102009053722.8
Nov. 18, 2009 (DE) 202009017699.1

(51) Int. Cl. F02B 43/00

(52) U.S. Cl. 123/300; 123/299

(57) ABSTRACT

A fuel injection method is provided for diesel engines, particularly diesel engines working according to the opposed piston principle, comprising several injection nozzles arranged in a tangential manner on the periphery of the cylinder. An approximately homogeneous mixing step is achieved by the geometric arrangement of the injection nozzles and by the individual control of the injection amount and of the temporal injection process.

The invention is in principle suitable for use in all diesel engines, but especially for use in opposed piston engines. These are characterised in that they do not have a cylinder head. Instead, the working gas is compressed between two pistons moving contrary to one another to the inner dead centre. Accordingly not only must the gas exchange take place through channels arranged on the circumference of the cylinder but also the fuel must be injected from the external cylinder circumference into the combustion chamber. Compared to the conventional mixing procedure this requires a fundamentally different arrangement of the injectors for injecting the fuel. Whereas in general the injection nozzle is mounted above the combustion chamber in—or near—the centre of the cylinder axis and the fuel is distributed from the inside to the outside by a plurality of nozzle holes, in the case of opposed piston diesel engines the fuel has to be injected from outside into the combustion chamber.

In order to achieve the homogeneous mixing process desirable in modern engines in the interests of lower exhaust emissions, the possibilities are greatly restricted with engines with central or approximately centrally arranged injection devices located above the combustion chamber. An approximately stoichiometric mixture is present only towards the end of the injection process. At the start of the injection the mixture is still too lean. This deficiency can be only partially rectified by a preliminary mixing before the start of the ignition, for example by a non-igniting preinjection. Also a very short injection time, which has ended the mixing procedure already shortly after the start of combustion, can be realised only to a limited extent, since it requires either large (disadvantageous for other reasons) injection holes or a very high injection pressure. A combustion process in which the fuel is fed from outside the combustion chamber and thus can be distributed in an advantageous manner onto the working gas offers a better possibility.

The object of the invention is therefore based on achieving a shorter injection time and also producing a gas-fuel mixture that is as homogenous as possible before the start of the combustion.

Accordingly, according to the invention two or more injection nozzles are arranged on the cylinder circumference in the region of the upper cylinder dead centres so that their injection jets are aligned in a tangential direction onto the centre of the volume contained in a rotationally symmetrically formed combustion chamber. The arrangement of a plurality of nozzles permits a simultaneous injection through all the nozzles, whereby a shorter injection time is achieved, as well as also according to the invention, if necessary, an injection in a different time sequence of the individual nozzles. In this case the fuel jet is guided through a spout formed as an injection channel on the upper side of the piston, from the edge of the cylinder into the combustion chamber.

In conventional nozzles arranged centrally in the cylinder head, a disadvantage is that the tip of the nozzle lies very close to the hottest part of the combustion chamber, whereas in the arrangement according to the invention the nozzles are located at the coldest points outside the combustion chamber. The conventional arrangement cannot however utilise the hot temperature to vaporise the fuel, since the base of the jet near the tip of the nozzle is still too compact and a high resolution exists only in the vicinity of the cold combustion chamber walls. On the other hand the method according to the invention has the advantage that the jet resolution becomes better the further it moves towards the centre of the hot combustion chamber, which also contributes to a quicker formation of a homogeneous mixture. Whereas in the conventional combustion process the installation of a second nozzle in the centre of the combustion chamber is not possible for geometric reasons, in the present process virtually as many nozzles as desired can be arranged on the circumference of the cylinder. This also enables a good mixing to be achieved with a very slight air swirl or vortex or even no swirl at all. This in turn means lower heat losses to the combustion chamber walls and therefore an improved efficiency.

### DESCRIPTION OF THE FIGURES

FIG. 1 shows a longitudinal section through an opposed piston engine. Two pistons 1 and 2 move counter to one another in an engine housing consisting of two crank housings 3 and 4 and two cylinder halves 5 and 6 that are connected to one another by a cylinder middle part 7. The pistons are driven by two crankshafts 8 and 9, as well as by the connecting rods 10 and 11. Their movement is synchronised by a gear drive 12. The central gear of this gear drive is mounted in a control housing 13 secured on the cylinder middle part 7 of the engine housing and rotates at half the crankshaft rotational speed in the four-stroke process. It drives a camshaft 14, which comprises cams for actuating an injection pump 15 and also has cams for controlling the gas exchange of the inlet and outlet by means of the sliding sleeves 16 and 17. By means of their displacement the annular gas channels 18 and 19 can be opened and closed independently of one another. The injection devices 21 are disposed in the middle of the combustion chamber 20 in the cylinder middle part 7, in order to inject the fuel into the combustion chamber 20 formed in the upper dead centre between the pistons 1 and 2. The combustion chamber 20 is designed to be rotationally symmetrical and its volume is uniformly split into both pistons 1 and 2.

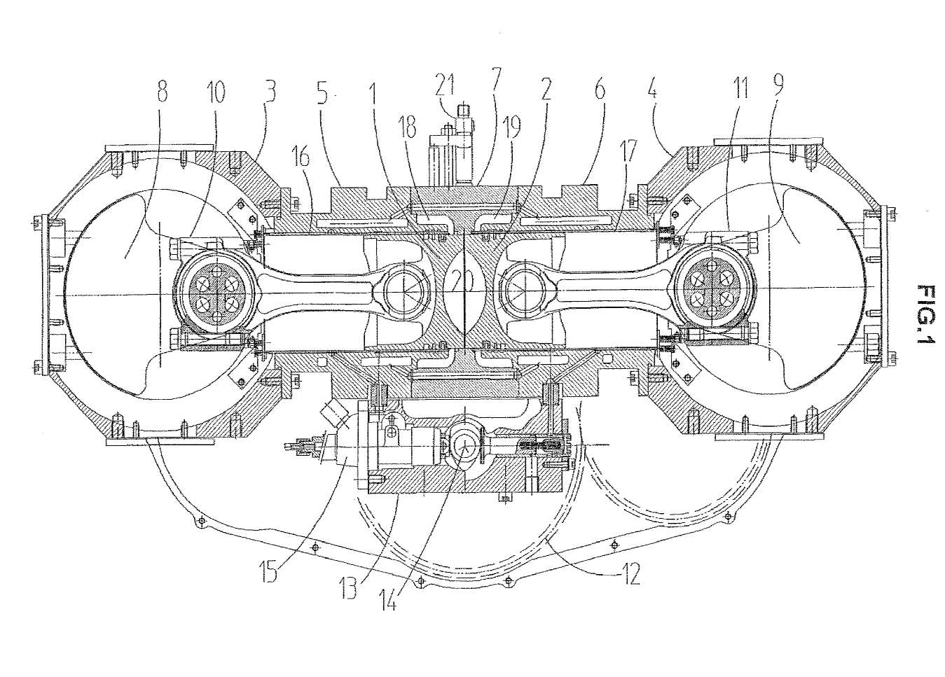

FIG. 2 shows a cross-section through the cylinder middle part 7. The fresh air feed 21 terminates in the region of an annular gas channel 18. In a similar manner to this, the exhaust gas is discharged from another annular gas channel through an exhaust pipe 32. In order to generate an air swirl for the mixing process the fresh air feed enters tangentially into one or more gas channels 18. Two nozzles 23 and 24 injecting fuel tangentially in the direction of the air swirl into the combustion chamber 20 are disposed in the centre of the combustion chamber. The pistons comprise spouts 25 pointing in the direction of the combustion chamber, so as to permit the passage of the fuel jet from the outer edge of the cylinder to the combustion chamber 20. The shape of the jet of the injecting nozzles is selected by means of one or more injection jets so that the bulk of the injected fuel is directed tangentially into the centre of the rotating air in the combustion chamber, since most of the fresh air for the mixing is also present there.

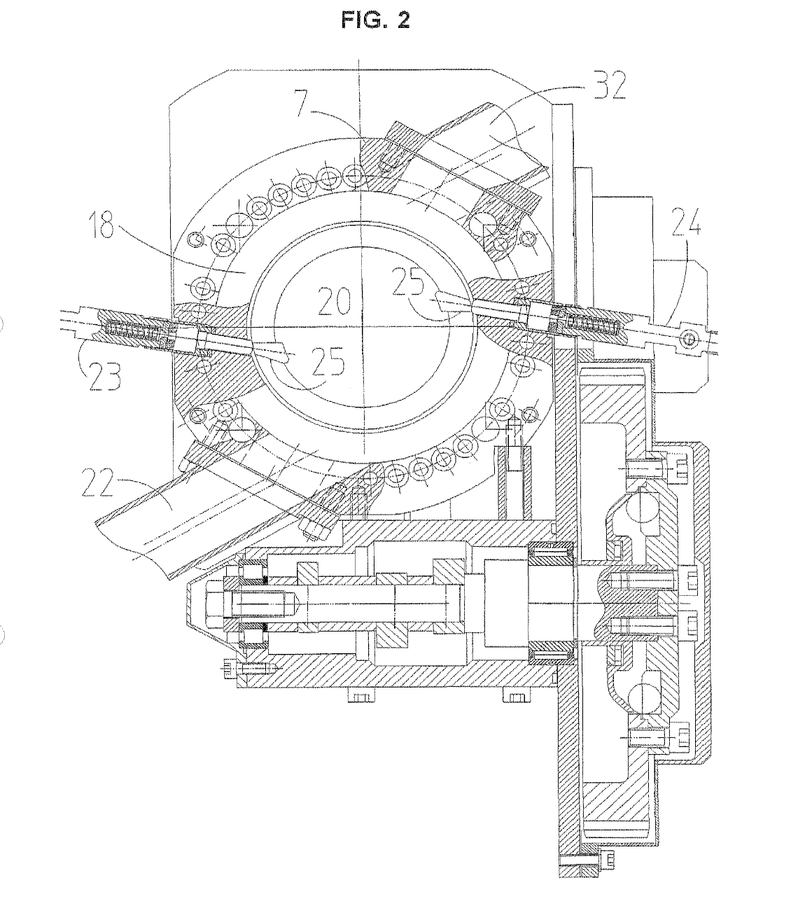

FIG. 3 shows an arrangement with three tangentially arranged injection nozzles 26, 27 and 28. The larger the number of nozzles distributed around the circumference, the smaller the necessary swirl of the fresh air needs to be in order to effect the mixing process. In principle this arrangement provides the advantage that the injection does not necessarily have to take place at the same time by means of a plurality of nozzles, but can also proceed serially, in the interests of a better, more homogeneous mixture formation.

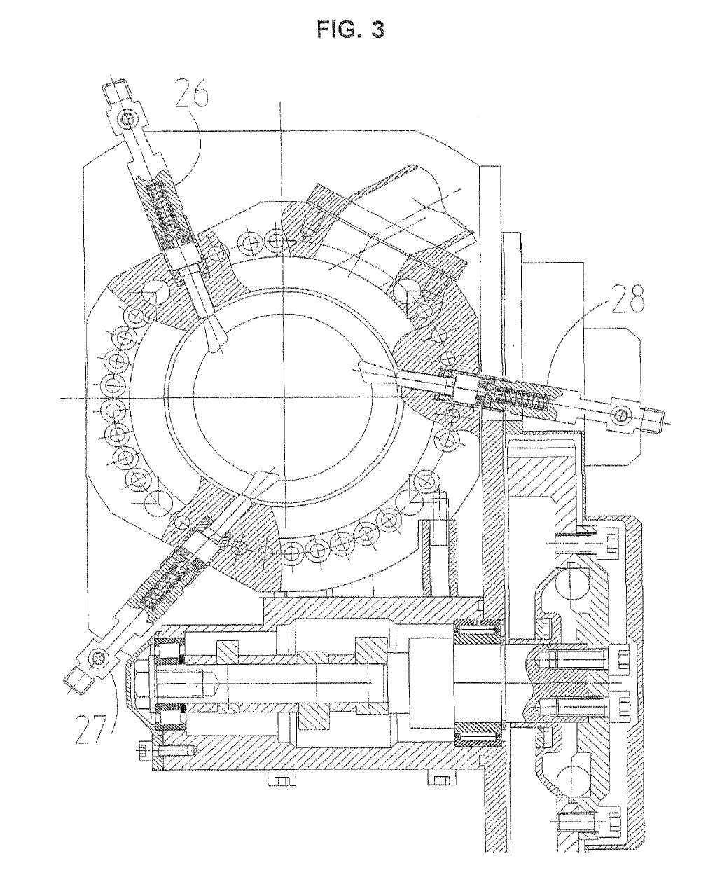

FIG. 4 shows the aforementioned arrangement with three tangentially arranged injection nozzles 26, 27 and 28, as well as mixing segments 29, 30 and 31 associated with each of these nozzles in the combustion chamber 20. Each of the nozzles thoroughly mixes only the segment respectively associated with it. This can take place simultaneously and also in a staggered manner, so that the next segment is only thoroughly mixed when the mixing process of the preceding segment is complete. In this connection neither do the nozzles necessarily have to be uniformly distributed around the circumference, nor do the mixing segments have to be the same size, nor does the injected amount of fuel have to be the same for all nozzles, and finally nor do the time intervals for the start of injection by the nozzles have to be equally long. Instead, all these parameters can be adapted individually to the requirements of an ideal mixing process for the respective operating state of the engine, for example by a plurality of mechanically driven individual injection pumps, or by electronic means and controls as in common-rail engines.

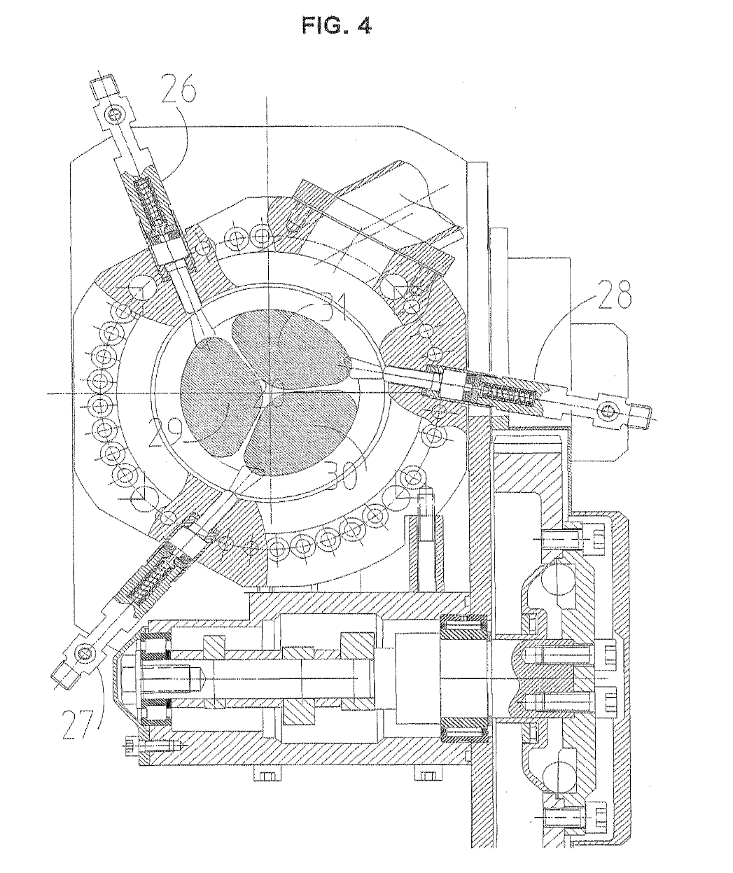

1. A fuel injection method for diesel engines with injection nozzles tangentially arranged on the circumference of the cylinder, wherein the fuel is injected from the circumference of the cylinder in the direction of the combustion chamber through two or more injection nozzles.

2. The fuel injection method for diesel engines according to claim 1, wherein the bulk of the injected amount of fuel is directed tangentially to the centre of the combustion chamber volume.

3. The fuel injection method for diesel engines according to claim 1, wherein the injection through the injection nozzles does not take place simultaneously, but in a timed sequence.

4. The fuel injection method for diesel engines according to claim 1, wherein a combustion chamber segment is associated with each nozzle for whose thorough mixing the nozzle is responsible, without resulting in an overlapping of the mixing segments.

5. The fuel injection method for diesel engines according to claim 4, wherein the mixing process for the individual combustion chamber segments takes place successively, wherein the first injections still take place during the compression stroke at a time at which the produced fuel-air mixture is still not ignitable, and only with the last injection is the compression sufficient to ignite the mixture.

6. The fuel injection method for diesel engines according to claim 4, wherein the combustion chamber in which the mixing process takes place is designed rotationally symmetrical.

7. The fuel injection method for diesel engines according to claim 1, wherein dedicated injection pumps are associated with each of the injection nozzles, the pumps being mechanically actuated by cams specifically associated with them on a camshaft, so that an independent start of the injection as well as an independent injection amount can be fed individually to each injection nozzle.

8. The fuel injection method for diesel engines according to claim 1, wherein the time sequence and the quantitative control of the nozzles is effected by an electronic control device with means as in the common-rail method, so that the most favourable mixing process in each case for the rotational speed/load characteristic field is plotted and controlled in corresponding control maps.

9. The fuel injection method for diesel engines according to claim 1, wherein the method is specifically used in an opposed piston engine.

10. The fuel injection method for diesel engines according to claim 9, wherein the volume of the combustion chamber in which the mixing process takes place is uniformly split between both opposed pistons.
